(19) United States
(12) Patent Application Publication
(10) Pub. No.: US 2004/0251309 A1
(43) Pub. Date: Dec. 16, 2004

(54) Token bearing magnetc image information in registration with visible image information

(75) Inventor: Michael Gerald Cove, Neenah, WI (US)

Correspondence Address: BANNER & WITCOFF, LTD., TEN SOUTH WACKER DRIVE, SUITE 3000, CHICAGO, IL, 60606, US

(73) Assignee: Appleton Papers Inc., Appleton, WI (US)

(21) Appl. No.: 10/458,124

(22) Filed: Jun. 10, 2003

(51) Int. Cl. G06K 19/06

(52) U.S. Cl. 235/493

(57) ABSTRACT

Disclosed is a security token that contains a magnetic information in registration with thermally generated information. Also disclosed are numerous security and authentication methods made possible using such token.

### TECHNICAL FIELD OF THE INVENTION

The invention is in the field of authentication tokens, including such tokens as security documents, badges, and the like. The invention is also in the field of security methods.

### BACKGROUND OF THE INVENTION

Security tokens have long been in use. The function of a security token is to authenticate either the token itself or the individual or other entity associated with the token. For instance, the token may take the form of a check or other negotiable document. Numerous security planchets, such as holograms, watermarks, and the like have been applied to such documents to make forgery and duplication of such tokens difficult.

Authentication tokens also may be used to identify the entity associated with the token, such as to provide identification information on a security badge or to identify the contents or destination of a box that bears a shipping tag. Often, an authentication token will contain numerous authenticating indicia, some of which are used to authenticate the token and some of which are used for other authentication purposes. For instance, credit cards and other financial transactions cards prepared in accordance with standards such as ISO 7810:1995, 7811-1, 7811-2, 7811-3, 7811-4, 7811-5, 7811-6, 7813 and related standards often contain one or more planchets, such as a hologram, in additional to magnetically encoded information. The magnetically encoded information identifies the account number of the cardholder and can be used to process transactions, such as purchases and debit withdrawals. The hologram is difficult to reproduce and the presence of the hologram is intended to provide assurance to the recipient of the card that the card is genuine.

Sophisticated forging techniques have been devised and continue to involve, and there is a continuing need for new forms of authentication tokens. Ideally, an authentication token should be difficult to forge or duplicate, and should be amenable to numerous uses, from non-security applications such as warehouse tags, to low security application such as library cards and “frequent guest” or “frequent diner” cards issued by restaurants and other businesses, to high security application such as access badges and secure documents. The invention seeks to provide such an authentication token, and also to provide methods and systems involving the same.

### THE INVENTION

It has now been discovered that a token can be imparted with magnetic image information in registration with visible information. In accordance with preferred embodiments in the invention, the token is provided with a thermosoft medium in which is disposed a plurality of magnetically alignable particles. The token also is provided with a thermally writeable layer that includes a material that is susceptible to a change in color upon heating. The thermally writeable layer may-be a separate layer that is provided in a laminar construction as a layer over and under the thermosoft medium in which the magnetically alignable particles are disposed, or alternatively the magnetically alignable particles and the thermally writeable layer may be disposed in a single layer on a substrate.

Various security and authentication methods are contemplated with such authentication token. For instance, the invention is contemplated to be useful in connection with a security check using a token. The security check may be as simple as determining whether the token contains magnetic image information in registration with visible image information. Alternatively, in addition thereto, the token or a security method involving a token may contemplate additional security checks. For instance, the token information, by which is contemplated information that is magnetically and/or visibly encoded on the token, may be further processed, such as by checking against a database of registered tokens, or by processing identification associated with the token.

Features of the preferred embodiments of the invention will be discussed hereinbelow with reference to the accompanying Figures, in which:

### SUMMARY OF THE FIGURES

FIG. 1 is a representation of an authentication environment that includes plural tokens.

FIG. 2 is a representation of a system useful in conjunction with obtaining information from an authentication token.

FIG. 3 is a plan view of an authentication token in the form of an idealized airline ticket that bears magnetic image information in registration with visible image information.

FIG. 4 is a plan view of an authentication token in a form of an idealized security badge that bears magnetic image information in registration with visible image information.

FIG. 5 is a flowchart representation of a method for determining whether to execute a positive match procedure.

FIG. 6 is a flowchart representation of a method for processing a token.

FIG. 7 is a flowchart representation of steps for processing a token and executing a positive match procedure.

FIG. 8 is a representation of a database record useful in conjunction with the method of FIG. 7.

FIG. 9 is a flowchart representation of steps in a method for processing a token and executing a positive match procedure.

FIG. 10 is a representation of a database record useful in conjunction with the method of FIG. 9.

FIG. 11 is a flowchart representation of steps of a method for processing a token and executing a positive match procedure.

FIG. 12 is a representation of a database record useful in conjunction with the method of FIG. 11.

FIG. 13 is a flowchart representation of steps of a method for processing a token and executing a positive match procedure.

FIG. 14 is a flowchart representation of a database record useful in conjunction with the method of FIG. 13.

FIG. 15 is a representation of an alternative database record useful in conjunction with the method of FIG. 13.

FIG. 16 is a flowchart representation of steps in a method for processing a token and executing a positive match procedure.

FIG. 17 is a representation of a database record useful in conjunction with the method of FIG. 16.

FIG. 18 is a representation of an alternative database record useful in conjunction with the method of FIG. 18.

FIG. 19 is a representation of steps in a method for processing a token and processing identification information.

FIG. 20 is a representation of a database record useful in conjunction with the method of FIG. 19.

FIG. 21 is a flowchart representation of steps and another method for processing a token and processing identification information.

FIG. 22 is a representation of a database record useful in conjunction with the method of FIG. 21.

FIG. 23 is a flowchart representation of steps in a method for storing information in a database record.

FIG. 24 is a flowchart representation of steps in a method for placing information onto a token.

FIG. 25 is an idealized process schematic showing magnetic image information being placed onto a token in registration with visible image information.

### DESCRIPTION OF THE PREFERRED EMBODIMENTS

The invention is contemplated to be applicable to authentication tokens which bear an indicia intended to authenticate the token itself as well as indicia for providing identification information, by which is contemplated information beyond that used to authenticate the token itself used in an authentication environment. The identification information, for instance, may be information sufficient to identify a person, a company, a room number, a billing code, a tracking unit, an account number, or, more generally, any other entity or information. The token itself may be any physical object used in an authentication environment. Non-limiting examples of authentication tokens include checks, money orders, currency, chits, tracking labels, warehousing tracking cards, tickets (e.g. transportation tickets, such as airline tickets, or event tickets, such as theater and sporting event tickets), merchandise tags, luggage tags, personnel badges (such as laboratory badges), security badges, “smart” cards, accesses cards, debit or credit cards, library cards, “frequent guest” or “frequent diner” cards, passports, visas, titles, licenses, registrations, deeds, other legal documents, negotiable documents, fobs, cards, keys, certificate of authenticity or authority, stock certificates, bonds, purchase order forms (such as business, governmental, or medicinal forms), shipping labels, postage tags or stamps, customs forms, labels, coupons, lottery tickets, casino chips, controlled documents, military and security tokens, and so forth. Generally, the invention is contemplated to be applicable in any environment wherein it is desired to confirm the authenticity of a token and/or to retrieve identification information from a token.

Physically, the token comprises a substrate on (or, in some instances, in) which magnetic information can be placed in registration with visible image information. Any methodology by which magnetic image information can be placed in registration with visible image information is contemplated to be useful in conjunction with the invention. In preferred embodiments of the invention, the token is provided as a substrate on which is imparted one or more layers, the layers including for instance, a magnetically writeable layer and a thermally writeable layer either in or disposed on a substrate, or a single magnetically thermally writeable layer. Other layers are contemplated to be useful in conjunction with the invention, for instance, a protective topcoat layer. The substrate useful in conjunction with the invention can be any suitable substrate, such as paper, a polymer film, cardboard, plastic, and so forth. Paper will often be the preferred substrate, particularly when the authentication token has a one-time or limited-time use (e.g., a ticket).

The thermally writeable layer may comprise any thermally responsive record material system now known or hereinafter may be discovered. Such systems are well known in the art and are described in many patents, including for example U.S. Pat. Nos. 3,539,375; 3,674,535; 3,746,675; 4,151,748; 4,181,771; 4,246,318; 4,470,057. In such systems, a basic chromogenic material and an acidic color developer material are contained in a coating on a substrate. When the coating is heated to a suitable temperature, the coating melts or softens to permit the material to react thereby producing a colored mark. Preferably, the formation of a colored mark is not reversible, and the colored mark is resistant to fading and erasure. Intermediate layers are permitted generally; and any film-forming material, preferably a clear material, can be used.

Coat weights can effectively be about 2 to 12 grams, more preferably 3 to about 9 grams per square meter (gsm), particularly for the thermally writeable layer and most preferably about 5 to about 6 gsm. The practical amount of the coatings, especially cost sensitive materials such as color-forming materials, is controlled by economic considerations, functional parameters and desired handling characteristics of the coated sheets. The components of the thermally writable layer are in a contiguous relationship, substantially homogeneously distributed throughout the coated layer material deposited on the substrate. In manufacturing the thermally writable layer, a coating composition is prepared which includes a fine dispersion of the components of the color-forming system, polymeric binder material, surface active agents and other additives in an aqueous coating medium. The composition can additionally contain inert pigments, such as clay, talc, aluminum hydroxide, calcined kaolin clay and calcium carbonate; synthetic pigments, such as urea-formaldehyde resin pigments; natural waxes such as Carnuba wax; synthetic waxes; lubricants such as zinc stearate; wetting agents; defoamers; and antioxidants. Other sensitizers can also be included. These sensitizers, for example, can include acetoacet-o-toluidine, phenyl-1-hydroxy-2-naphthoate, 1,2-diphenoxyethane, and p-benzylbiphenyl.

The color-forming system components are substantially insoluble in the dispersion vehicle (preferably water) and are ground to an individual average particle size of between about 1 micron to about 10 microns, preferably about 1-3 microns. The polymeric binder material is substantially vehicle soluble although latexes are also eligible in some instances. Preferred water soluble binders include polyvinyl alcohol, hydroxy ethyl-cellulose, methylcellulose, methyl-hydroxypropylcellulose, starch, modified starches, gelatin and the like. Eligible latex materials include polyacrylates, styrene-butadiene-rubber latexes, polyvinylacetates, polystyrene, and the like. The polymeric binder is used to protect the coated materials from brushing and handling forces occasioned by storage and use. Binder should be present in an amount to afford such protection and in an amount less than will interfere with achieving reactive contact between color-forming reactive materials.

Electron-donating dye precursors are also known compounds. These electron-donating dye cursors or chromogens include chromogenic compounds such as the phthalide, leucoauramine and fluoran compounds. These chromogenic materials or electron donating dye precursors are well known color-forming compounds for use in color-forming record systems. Examples of the compounds include Crystal Violet Lactone (3,3-bis(4-dimethlaminophenyl)-6-dimethlaminophthalide, (U.S. Pat. No. RE 23,024); phenyl-, indolyl, pyrrolyl, and carbozolyl-substituted phthalides (for example, in U.S. Pat. Nos. 3,491,111; 3,491,112; 3,491,116; 3,509,174); nitro-, amino-, amido-, sufonamido-, aminobenzylidene-, halo-, anilino-substituted fluorans (for example, the U.S. Pat. Nos. 3,624,107; 3,627,78; 3,641,011; 3,642,828; 3,681,390); spirodipyrans (U.S. Pat. No. 3,971,808); and pyridine and pyrazine compounds (for example, in U.S. Pat. Nos. 3,775,424 and 3,853,869). Other specifically eligible chromogenic compounds, not limiting the invention in any way, are: 3-diethylamino-6-methly-7-anilino-flouran (U.S. Pat. No. 4,510,513); 3-dibutylamino-6-methyl-7-anilino-fluoran; 3-dibutylamino-7-(2-chloroanilino) fluoran; 3-(N-ethyl-N-tetrahydrofurfurylamino)-6-methyl-7-3,5′6-tris(dimethylamino)spiro[9H-fluorene-9,1′(3′H)-isobenzofuran]-3′-one; 7-(1-ethyl-2-methylindole-3-yl)-7-(4-diethylamino-2-ethoxphenyl)-5,7-dihydrofuro[3,4-b]pyridin-5-one (U.S. Pat. No. 4,246,318); 3-diethylamino-7-(2-chloroanilino)fluoran (U.S. Pat. No. 3,920,510); 3-(N-methylcyclohexylamino)-6-methyl-7-anilinofluoran (U.S. Pat. No. 3,959,571); 7-(1-octyl-2-methylindole-3-yl)-7-(4-diethylamino-2-ethoxyphenyl)-5,7-dihydrofuro[3,4-b]pyridin-5-one; 3-diethylamino-7,8-benzofluoran; 3,3-bis(1-ethyl-2-methylindole-3-yl)phthalide; 3-diethylamino-7-anilinofluoran; 3-diethylamino-7-benzylaminofluoran; 3′-pheny-7-dibenzylamino-2,2′-spirodi-[2H-1-benzopyran] and mixtures of any of the foregoing.

Examples of eligible acidic developer material include the compounds listed in U.S. Pat. No. 3,539,375 as phenolic reactive material, particularly the monphenols and diphenols. Eligible acidic developer material also includes, without being considered as limiting, the following compounds which may be used individually or in mixtures; 4,4′-isopropylidinediphenol (Bisphenol A); p-hydroxybenzaldehyde; p-hydroxybenzopenone; p -hydroxypropiohenone; 2,4-dihydroxybenzophenone; 1.1-bis(4-hydroxyphenyl)cyclohexane; salicylanlide; 4-hydroxy-2-methylacetophenone; 2-acetylbenzoic acide; m-hydroxyacetanilide; p-hydroxyacetanlide; 2,4-dihydroxyacetophenone; 4-hydroxy-4′-methylbenzophenone; 4,4′-dihydroxybenzophenone; 2,2-bis(4-hydroxyphenly)-5-methylhexane; benzyl(4-hydroxphenyl) pentanoate; isopropyl-4,4-bis(4-hydroxphenyl) pentanoate; methyl-4,4-bis(4-hydroxyphenyl) pentanoate; alkyl-4,4-bis(4-hydroxphenyl) pentanoate; 3,3-bis(-hydroxyphenyl) pentane; 4,4-bis(4-hydroxphenyl) heptane; 2,2-bis(4-hydroxyphenyl)-1-phenylpropane; 2,2-bis(4-hydroxphenyl) butane; 2,2′-methylene-bis(4-ethyl-6-tertiarybutyl phenol); 4-hydroxycoumarin; 7-hydroxy-4-methylcoumarin; 2,2′-methylene-bis(4-octyl phenol); 4,4′-sulfonyldiphenol; 4,4′-thiobis(6-tertiarybutyl-m-methylene-bis(4-octyl phenol); 4,4-sufonyldiphenol; 4,4′-thiobis(6-tertiarybutyl-mcresol); methyl-p-hydroxybenzoate; n-propyl-p-hydroxybenzoate; benzyl-p-hydroxybenzoate. Preferred among these are the phenolic developer compounds. More preferred amount the phenol compounds are 4,4-isoproylindinediphenol, ethyl-4,4-bis(4-hydroxyphenyl)-pentanoate, n-proply-4,4-bis(4-hydroxyphenyl) pentanoate, isopropyl-4,4-bis(4-hydroxyphenyl) pentanoate, methyl 4,4-bis(4-hydroxyphenyl)pentanoate, 2,2-bis(4-hydroxyphenyl)-4-methylpentane, p-hydroxybenzophenone, 2,4-dihydroxybenzophenone, 1,1-bis(4-hydroxyphenly) cyclohexane, and benzyl-p-hydrozybenzoate. Acid compounds of other kind and types are eligible.

Examples of other developer compounds are zeolites, phenolic novolak resins which are the product of reaction between, for example, formaldehyde and a phenol such as an alkyphenol, e.g., p-octyphenol, or other phenols such as p-phenyphenol, and the like; and acid mineral materials including colloidal silica, kaolin, bentonite, attapulgite, haoosyte, and the like. Some of the polymers and minerals do not melt but undergo color reaction on fusion of the chromogen.

The token also is provided with a plurality of magnetic particles as metalized fibers, metal fibers or particulates disposed in a themosoft medium. Generally, the magnetic particles can be magnetities that are elongate, rice grain, platelet or particulate, and can be of three types: cubic or soft; octahedral; or acicular or hard. Cubic magnetites are the least expensive. The magnetites may be hard, soft or a mixture thereof. The magnetic particle can comprise magnetic iron oxide or ferromagnetic or ferrimagnetic particles such as taught in U.S. Pat. No. 3,883,392 or more preferably acicular magnetic particles such as taught in British Patent No. 1,331,604 or mixtures. Particle sizes can be submicron.

Dispersions of acicular magnetic particles are suitable for carrying out the present invention. For example, non-stoichiometric iron oxide particles are useful. The magnetic layer can comprise acicular magnetic particles in a binder. The magnetic particles may consist of a metal or alloy as a dispersion in a binder, such as the particles taught in British Pat. No. 1,183,479, which discloses a method of orienting magnetic particles in a liquid. British Pat. No. 1,331,604 relates to the recording of information, especially security information, onto cards having magnetic layers thereon. The cards according to the '604 patent, are provided with a magnetic water mark by orienting preselected areas of a coating consisting of acicular magnetic particles in a binder, while the coating is in a liquid state, followed by causing the coating to solidify. Such particles could be adapted to beneficial use in the present invention.

The magnetic materials may consist of acicular magnetic particles, such as magnetite, iron oxide, or chromium dioxide. The magnetic material particles can be composed of any of ferromagnetic iron oxides such as γFe₂O₃, Co coated γFe₂O₃, Co coated magnetite, Co containing magnetite, ferromagnetic chromium dioxide, ferromagnetic metals, ferromagnetic alloys, Ba ferrite of hexagonal system, Sr ferrite, Pb ferrite and Ca ferrite or similar material dispersed in the thermosoft medium which can optionally also include binders, plasticisers, etc. The configuration thereof may be acicular, rice grain, spherical, cubic and plate shapes. Particles exhibiting some directionality are useful.

The magnetic materials may optionally be surface treated with silica and/or alumina or an organic material. Further, the magnetic material grains optionally may have their surface treated with a silane coupling agent or a titanium coupling agent. The thermosoft medium may be any medium which becomes soft at the temperature intended to be used and thereby permits magnetic alignment of at least a portion of the particles. The preferred thermosoft medium is polyvinyl alcohol, which may be cast into a thermosoft film via known methods or coated as a liquid dispersion. Other thermosoft mediums can include fatty acid esters, poly(ethylene) oxides, acrylate dispersions, cellulose ethers, bees wax, Carnauba wax, glycerol esters, polyalkylene glycols and various water dispersible resins and gums. The preferred medium can be applied as a water dispersion, has film-forming or binder character, and softens upon heating. The coatings can be applied by casting or by means of common industrial coaters such as air knife coater, blade coater, rod coater, roll coater, bar coater, flexo coater, size press, curtain coater and the like. Coat weights can be from about 2 to 12 grams per square meter. These coat weights are illustrative only and the invention can be practiced with more or less coating depending on desired functionality or durability. It is contemplated that the magnetic particles may be disposed in the same medium as the material which gives rise to a thermally writeable property, thus forming a thermally and magnetically writeable layer disposed on the substrate. The thermosoft medium can include materials such as polyvinyl alcohol, carboxylated polyvinyl alcohol, waxes, natural or synthetic, polyvinyl acetate emulsions. Polyvinyl alcohols are preferred since they can be handled as water borne suspensions. Thermoplastic emulsions dispersed in organic solvents can also be used as the thermosoft medium.

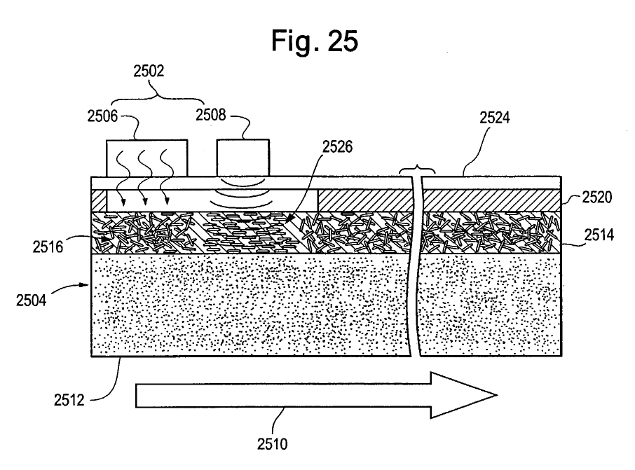

FIG. 25 illustrates a recorder 2502 and token 2504 onto which magnetic image information is being placed in registration with a thermally written image. As shown, the recorder includes a thermo head 2506 and a magnetic head 2508. A roller or other system conveys the token 2504 through the recorder 2502 (roller not shown). In the illustrated embodiment, the token moves in the direction indicated by arrow 2510. The illustrated token includes a substrate 2512 and a magnetic layer 2514 that includes magnetic particles 2516 in a thermosoft medium. A thermo layer 2520 that is susceptible to a change in color upon heating is disposed over the magnetic layer 2514, and a topcoat layer 2524 is disposed over the thermo layer 2520. Again, the structure of the token may be otherwise than as illustrated, for instance, the thermo layer may be disposed beneath the magnetic layer, or one or more intermediate layers may be provided. The magnetic layer can be continuous or spot printed.

In operation, the substrate passes first beneath the thermo head 2506, which causes color to form in the thermo layer (in the illustrated embodiment the color is black, but other colors are conceivably possible). Immediately after leaving the thermo head, the substrate pass beneath the magnetic head 2508 which causes alignment of the magnetic particles proximal to the magnetic head, as shown with reference to particles 2526. Thus, the token is provided with a thermally generated visible image in registration with a magnetic image. The image may be a simple as a block or line on the substrate, or may be more complex, such as a one-or two-dimensional bar code, text, or other marking. The invention also contemplates a reader (not shown) which includes a device for retrieving a visual image from a substrate (such as a laser or OCR reader) and a magnetic head for retrieving magnetic image information from the token.

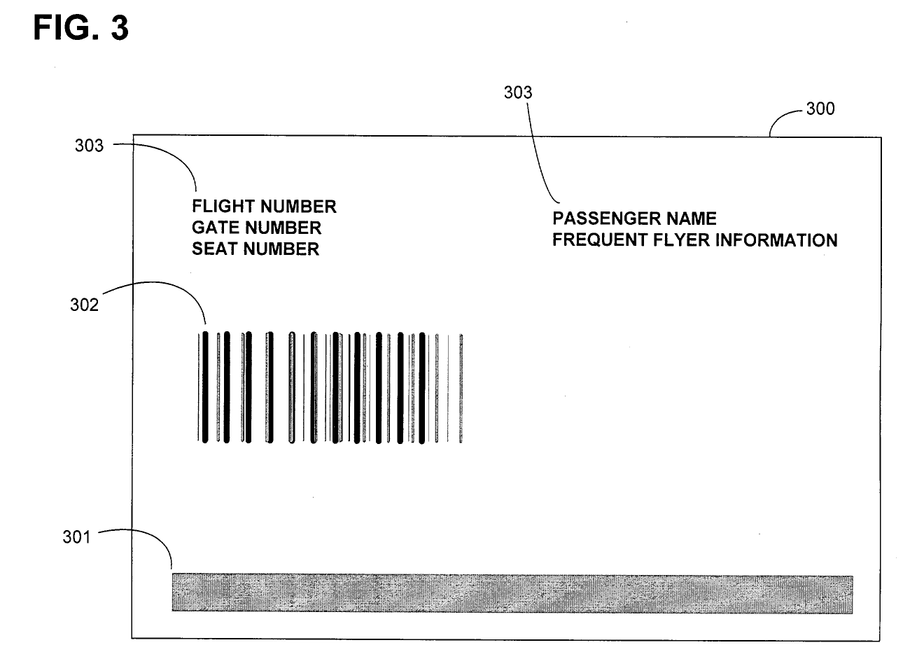

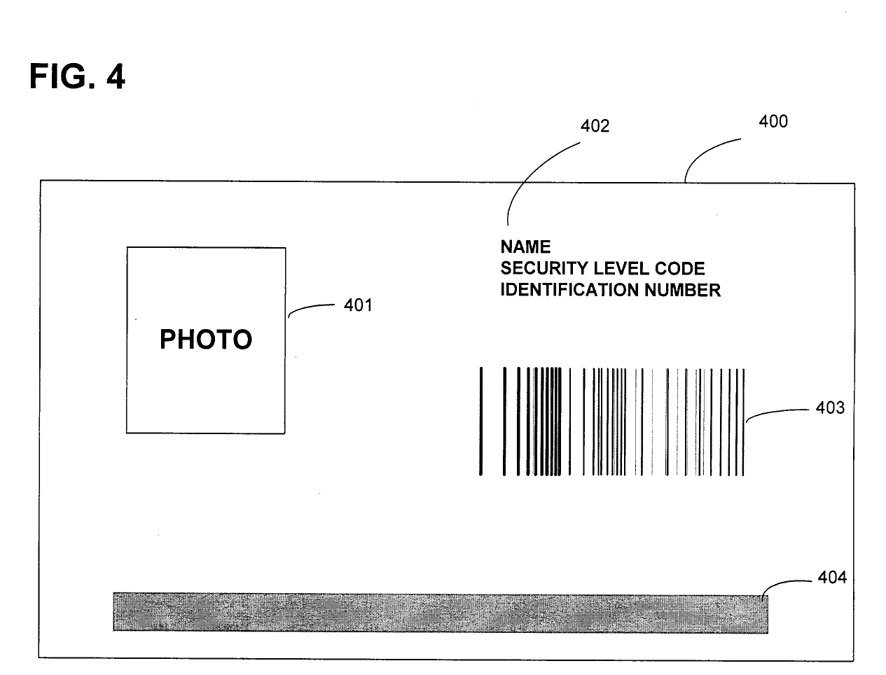

In practice, it is contemplated that a token will include numerous other forms of information. For instance, with reference the airline ticket 300 illustrated in FIG. 3, the ticket is imparted with a magnetic barcode strip 301 on to which magnetic information may be imparted (for instance, in accordance with standards such as ISO 7810:1995, 7811-1, 7811-2, 7811-3, 7811-4, 7811-5, 7811-6, and 783). The ticket 300 further includes a barcode 302 which has been generated by a writer in accordance with the invention and which includes magnetic image information in registration with the visible barcode information. Text information 303 is further included. The text information 303 may be generated with a thermo head of a reader in accordance with embodiments of the invention. The magnetic layer may be included only in a region of the substrate barcode 302 or, alternatively, it may be included over the entire surface of the substrate. For instance, if the magnetic image information is only region of the barcode 302, the thermo head may not be applied in thermally printing the text information 303. It is conceivable, in embodiments of the invention wherein a thermo layer is separate from a magnetic layer, that the thermo and magnetic layers will be responsive at different temperatures. For instance, some portions of the card may contain a thermally generated image not in registration with a magnetic image and vice-versa. With reference to FIG. 4, and the security badge 406 shown therein, the badge may be provided with a photo 401 in additional to text information 402, a barcode 403, and a magnetic strip 404.

Numerous other forms of additional token information or authentication devices may be imparted onto the substrate. For instance, as set forth in more detail in copending U.S. application Ser. No. 10/377,534, the substrate may include scent formulation information. Examples of heretofore described security planchettes and associated methods are based on detection on transmitted radiation, rub-off overlays, measurement of physical dimensions marking on the card, use of special inks such as ultra-violet and infra-red, microprinting, intaglio, latent images based on visible, magnetic, or otherwise latent images, inks that are chemical or thermally activated, holograms, special construction (such as laminated construction) biometrically encoded information (such as DNA information, iris information, finger print information, photo information, voice information, gait information) taggents, special fibers, watermarks, and so forth. In one embodiment, for instance, information is magnetically encoded in accordance with ANS1/ISO/IEC 7811-2, which provides for a three-track recording strip that allows for longitudinal redundancy check. In some embodiments, papers that contain structured magnetic particles such as these sold under the trademark TechMark™ by Appleton Papers Inc. of Appleton, Wis. may be employed.

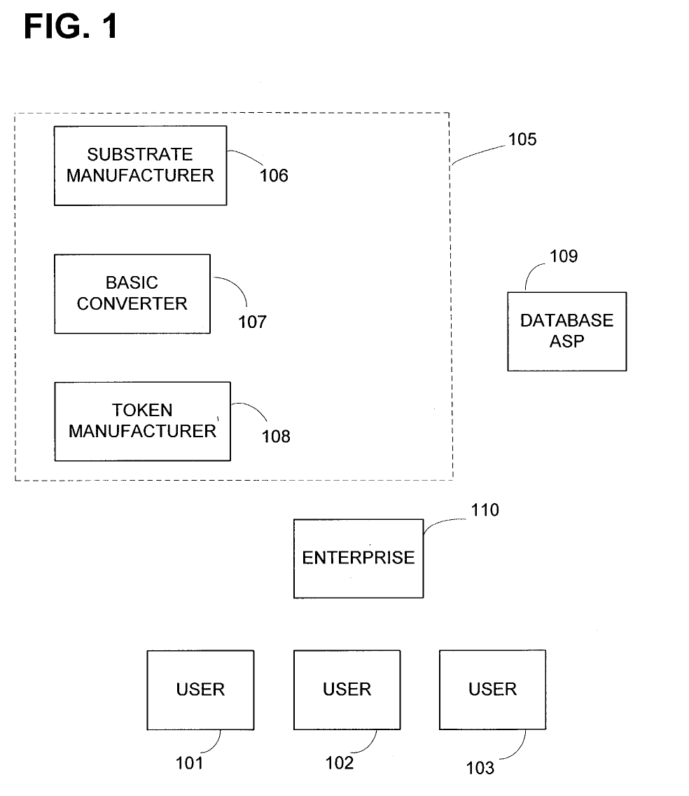

It is contemplated that the registration of magnetic image and visual image information on a token may be used in connection with various security methods. In some methods, the presence or absence of registration of visual and magnetic image information may be used as a determinant in a security method. Alternatively, or additional thereto, the information carried in the thermally generated image and/or the magnetic image may be used in conjunction with further processing of the token or in conjunction with a security or authentication method. In either instance, with reference to the environment illustrated in FIG. 1, an enterprise 110 obtains tokens from a token provider 105. Token provider may be a single entity, or plural entities, such as a base substrate manufacture 106, a converter 107 and a token manufacture 108. With respect to the substrate manufacturer, it is contemplated that the tokens may be generated via conventional methods of coating one or more layers onto paper and other substrates such as by using a air knife coater, blade coater, rod coater, roll coater, bar coater, multi-head coaters, flexo coater, size press, curtain coater or the like. The enterprise 110 obtains tokens and distributes the tokens to various users 101, 102, and 103. The enterprise may be, for instance, an airline, and users may be passengers each receiving a ticket or boarding pass from the airline directly or indirectly through an authorized distributor. The converter 107 may be an entity such as a sheeter, who cuts the paper into ticket form. The token manufacturer 108 may be a separate entity who purchases ticket blanks from the converter and generates tickets for the enterprise.

Optionally, the environment contemplates a database application service provider 109, which is an entity that maintains information pertaining to the tokens that could be useful in conjunction with activities of the enterprise. The database application service provider may be remote from the other entities, and the other entities may communicate with the database application service provider via a network (such as TCP/IP network, including for instance the Internet). Exemplary disclosure concerning the role of a database application service provider may be found in copending, commonly assigned U.S. application Ser. No. 10/375,078 entitled “System And Method For Tracking And Authenticating Items Through An Internet Website”, filed Feb. 28, 2003. In highly secure embodiments, it is contemplated that the information pertaining to the tokens is not directly known to the token manufacturer or to the enterprise, but is known only to the database application service provider and/or the token manufacture. Forgery of tokens becomes exceedingly difficult, because a forger would require information and equipment not only for application of the various layers on to the token substrate but also as to the particular information and formal information lodged with the application service provider. The enterprise may communicate directly with the application service provider after retrieving information from a token for data comparison. Alternately, or in addition thereto, the database application service provider periodically may provide an updated set of information directly to the enterprise; for instance, the information encoded on an airline ticket may be expected to change monthly.

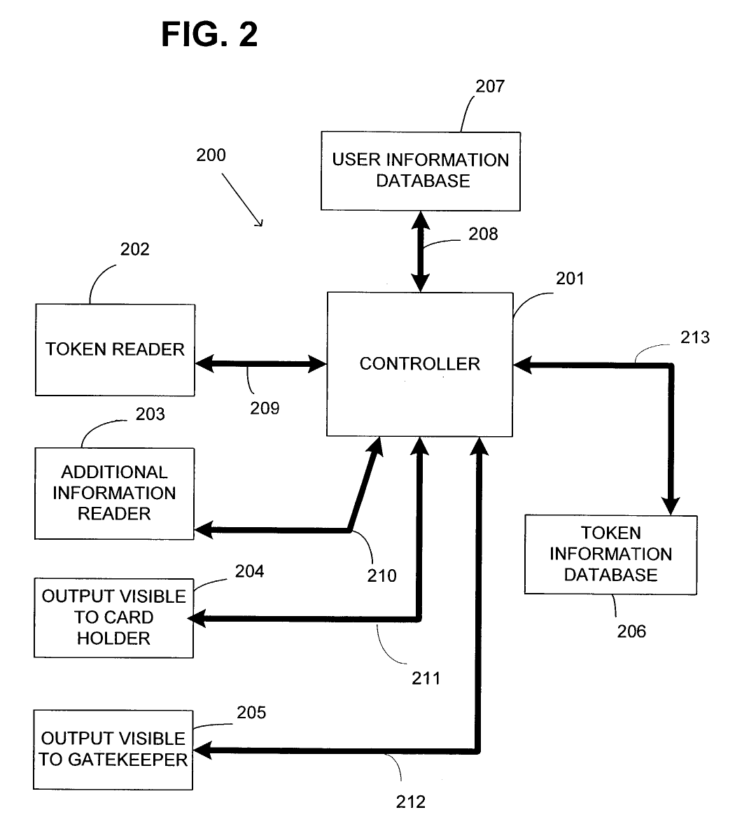

With reference to FIG. 2, the enterprise may employ a system such as a system 200. The system includes a controller 201, which may be any micro-controller, micro-processor, computer or like device and which typically is provided with read-only memory (ROM), random-access memory (RAM), storage (such as a disk drive or like storage means), and numerous inputs/output (I/O) devices such as a monitor, access control devices, and the like. The token reader 202 communicates with the controller via communication 209. In this figure, the communication 209 is shown via a two-headed arrow, but this in not intended to signify any structure, and it is contemplated, for instance, that the communication may take place via a data bus, asynchronous communication, or other device or methodology. For instance, if the token is an airline ticket, such as airline ticket 300, the barcode may be visually scanned and magnetic image information may be retrieved by the reader. It is contemplated that the textual indicia also may be readable via OCR by the reader and that the magnetic strip includes magnetically encoded information that may be read by the reader. Electronic signals corresponding to the information read are conveyed to the controller via communication 209. The controller processes the information, optionally by communication 213, with a token information database 206, which is a database that contains sufficient information to authentic the token. Upon a receipt of a database record via communication 213, the controller registers the passenger by communicating with a user information database 207 via communication 208. The controller may generate an output 204 visible to the ticket holder for instance, a green light signifying that the ticket has been properly processed. If the ticket is not found to be genuine, the output may be a red light indication a problem with ticket.

In another application, with reference to the security badge 400 illustrated in FIG. 4, the system may be provided with an additional information reader 203, which may be, for instance, a keypad for receiving input of a user's personal identification number or input code. This information is communicated to the controller via communication 211. The controller may verify the authenticity of the token via reference to token information database 206 and may log the user as having entered the facility in user information database 207. The controller may generate two forms of output, one visible to the user and one visible to the gatekeeper (see 205), which may be, for instance, a security guard. Thus, for instance, if the user presents a token that is invalid, the output that is visible to the gatekeeper may or may not be visible to the person presenting the badge. FIG. 2 is highly idealized, and numerous alterations and additions are possible. It is conceivable, for instance, that the token information database and user information database may be integrated. It is likewise envisioned that numerous components may be added to such a system.

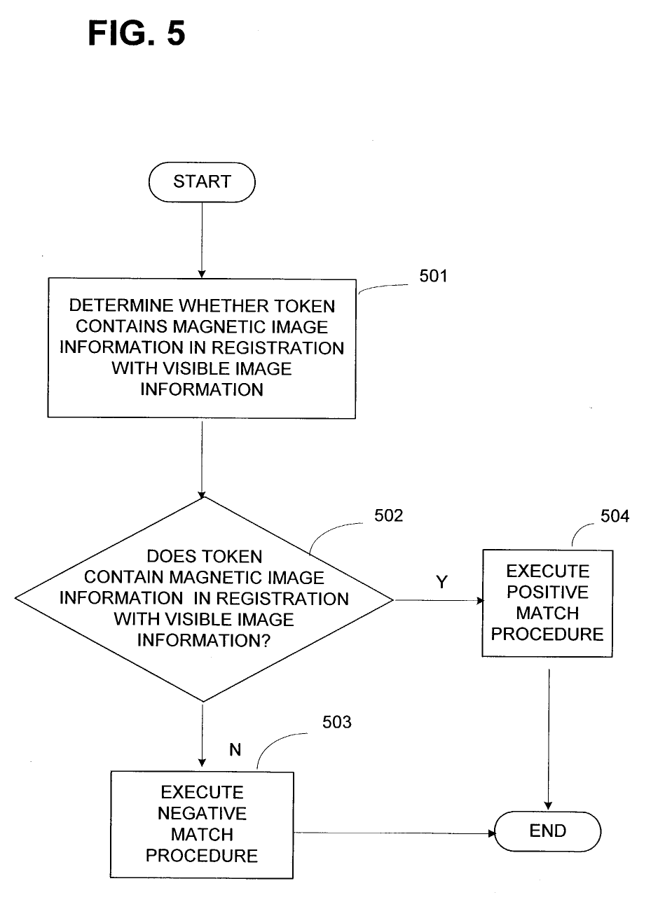

A general security methodology is shown in FIG. 5. In this and subsequent flowchart figures, the steps preferably represent steps in a computer program which may be running on any suitable computer and which may be programmed via any suitable programming technique (such as a program written in C++ running on a computer under the Windows operating system). With further reference to FIG. 5, at step 501, it is determined whether the token contains magnetic image information in registration with visible image information. If, at step 502, it is determined that the token does contain magnetic image information in registration with visible image information, control passes to step 504, wherein a positive match procedure is executed. The embodiment shown in FIG. 5 contemplates that the positive match procedure will be executed if and only if the token does contain magnetic image information in registration with visible image information; however, it is contemplated in some embodiments that the positive match procedure will be executed only if (but not necessarily if) the token contains magnetic image information in registration with visible image information. If at step 502, it is found that the token does not contain magnetic image information in registration with visible image information, the control passes to step 503, wherein a negative match procedure is executed.

The positive match procedure and negative match procedure may be any procedures suitable for use in connection with the intended purpose of the token. For instance, the positive match procedure may be allowing a passenger to board an airline or allowing a user into a secure facility. As further discussed in copending U.S. application Ser. No. 10/375,078 referred to hereinabove, a positive match procedure may be allowing access to a database for purposes of modifying the information contained in the database or for other purposes such as verifying authenticity or tracking of items. The negative match procedure again may be any suitable procedure, such as subjecting the user or passenger to additional scrutiny, denying the user or passenger permission to proceed further, or subjecting the user or passenger some other additional security measure. For instance, as discussed copending application Ser. No. 10/375,078 referred to hereinabove, the negative match procedure may be an act of sending a fraud alert.

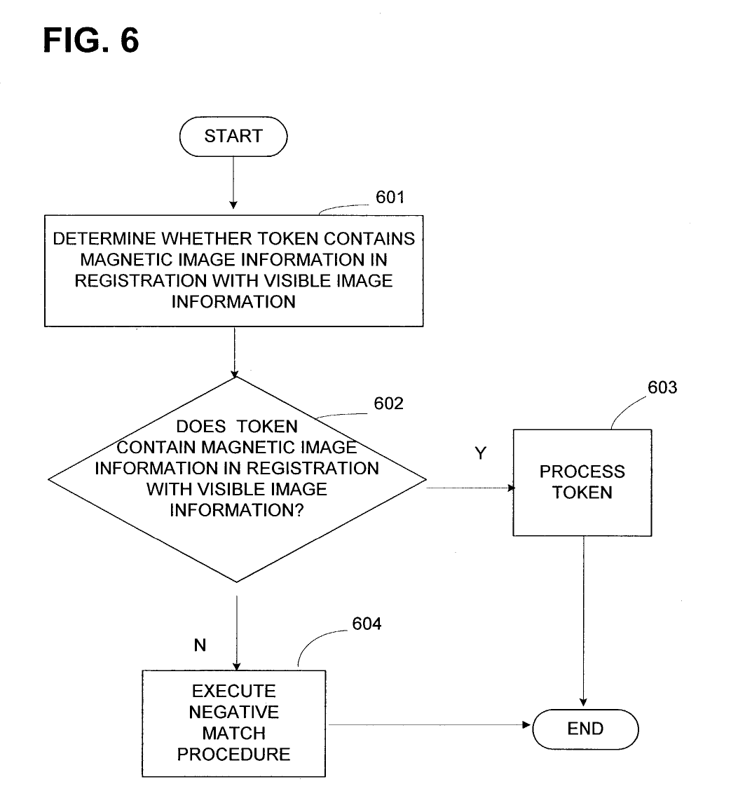

With reference to FIG. 6, a general methodology for processing a token is provided. At step 601, it is determined whether the token contains magnetic image information in registration with visible image information. If, at step 602, it is determined that the token does contain magnetic image information in registration, control passes to step 603 wherein the token is processed, for instance, as discussed hereinbelow. If, on the other hand, it is determined that the token does not contain magnetic image information in registration with visible image information, control passes to step 604 and a negative match procedure is executed.

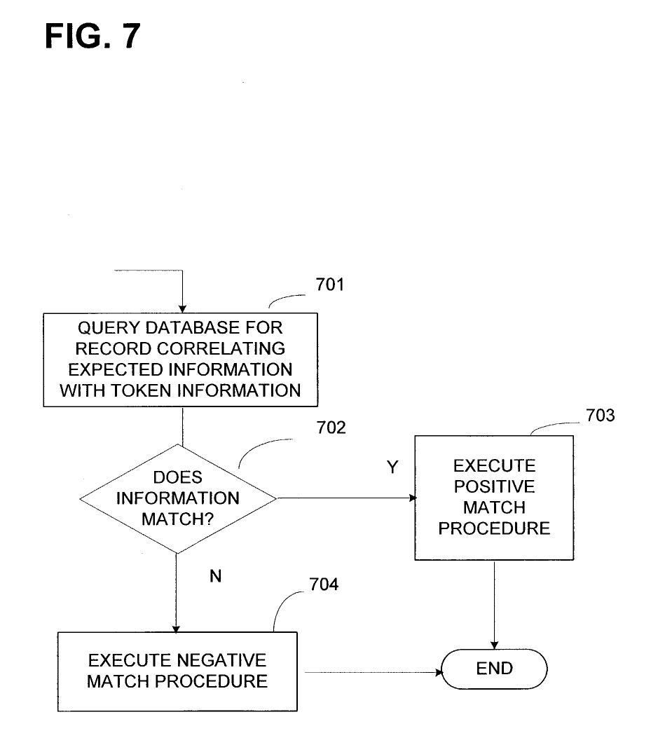

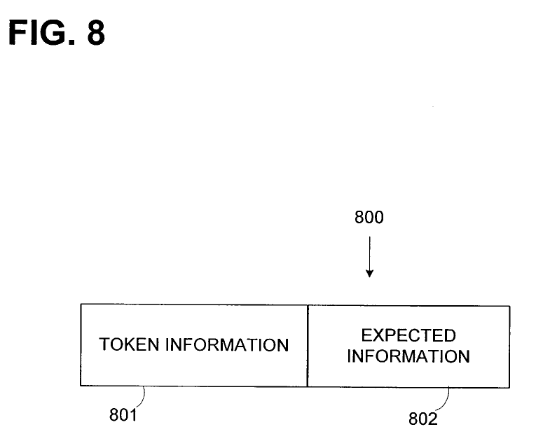

With further reference to FIG. 7, for instance, the processing of the token may include querying a database for a record correlating expected information with token information, the token information including one or both of magnetic image information and visible information. If, in step 702, it is determined that the expected information does match the token information, control passes to step 703, wherein a positive match procedure is executed. If, on the other hand, the information is determined to not match, a negative match procedure is executed at step 704. As shown in FIG. 8, the token information and expected information may be contained in a database record 800. In practice, it is contemplated that a more complex database may be provided.

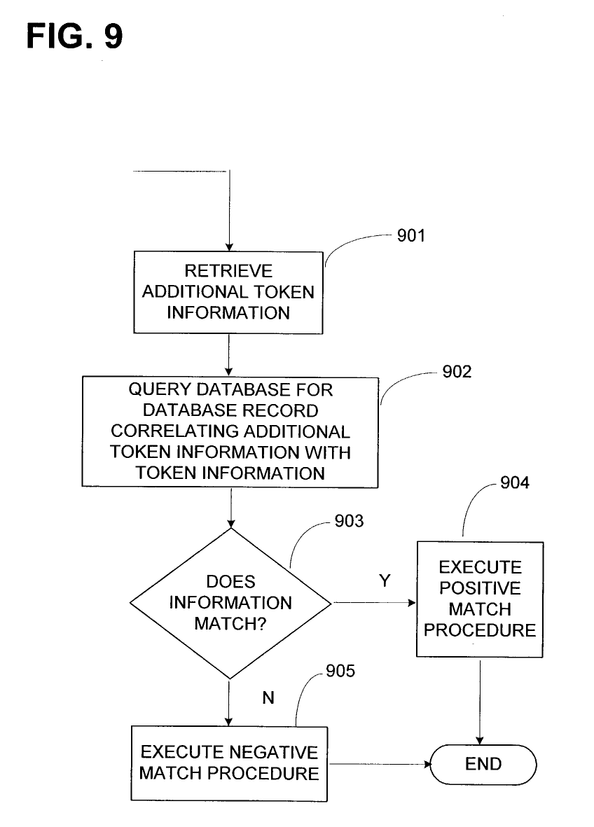

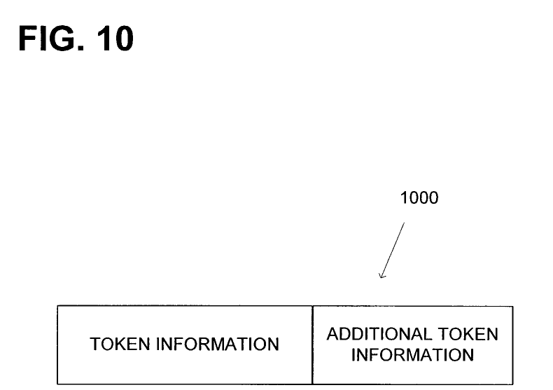

An alternative method for processing a token, as shown in FIG. 9, may include retrieving additional information from the token in step 901. For instance, a barcode or thermally generated image other than one in registration with magnetic image information may be scanned and information thereby obtained, or conversely magnetic image information encoded in the token, but not in registration with visible image information may be obtained. The additional token information may further include, for instance, retrieving any suitable information from any authentication device on the token. At step 902, a database is queried for a record that correlates additional token information with token information, the token information again being the visible image information and/or magnetic image information that are in registration with one another. If, at step 903, it is determined that the information matches, a positive match procedure can be executed in step 904. If, on the other hand, the information does not match, the negative match procedure is executed in step 905. Again, with reference to the database record 1000 shown in FIG. 10, the token information and additional token information may be provided as the sole component of the database record, but in practice it is contemplated that other database cells will be included.

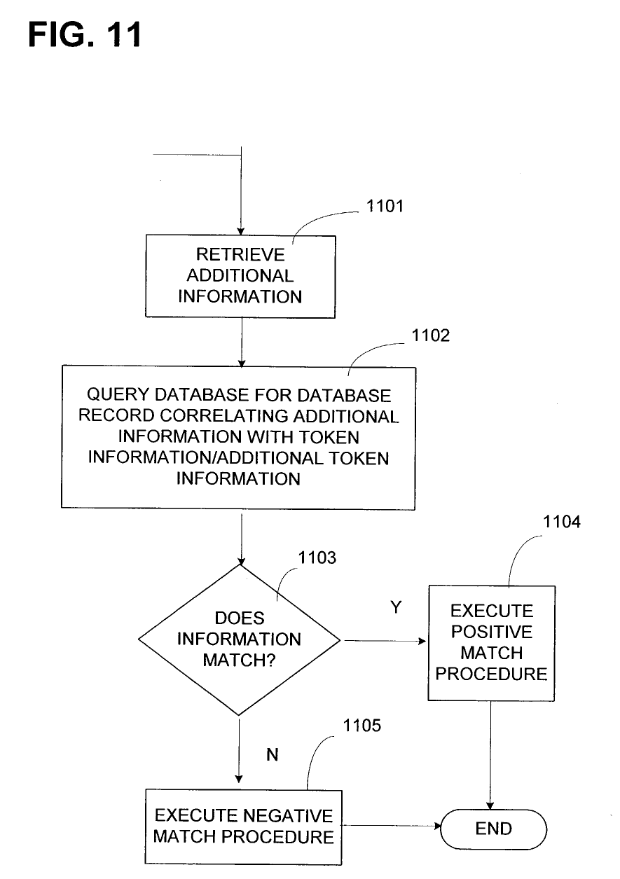

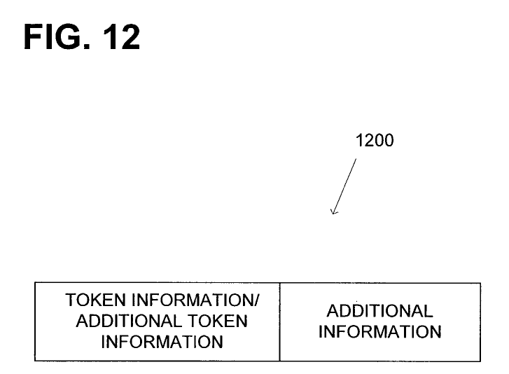

Steps 1101-1105 in FIG. 11 are generally comparable to steps 901-905 in FIG. 9, except that instead of retrieving additional token information, additional information, such as a personal identification number, is retrieved. In step 1102, it is contemplated that the database record may correlate additional information with the token information or with additional token information, as shown, for instance at 1200 in FIG. 12.

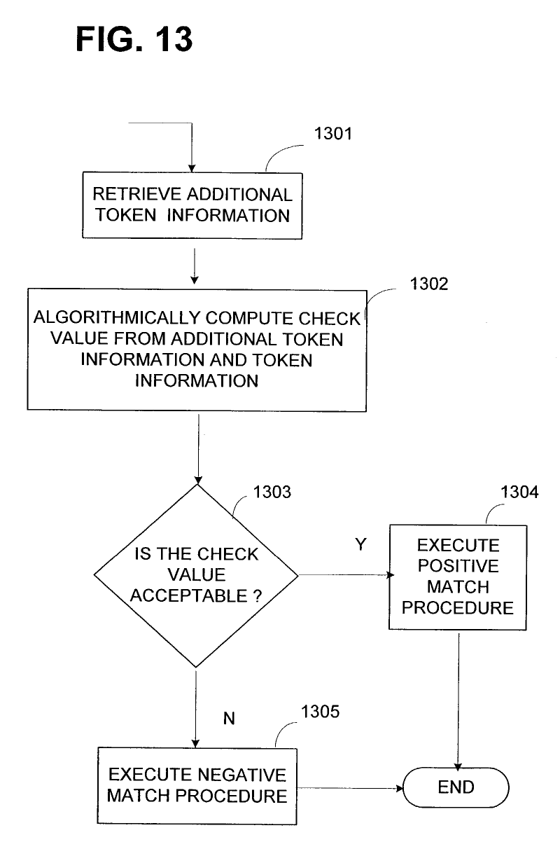

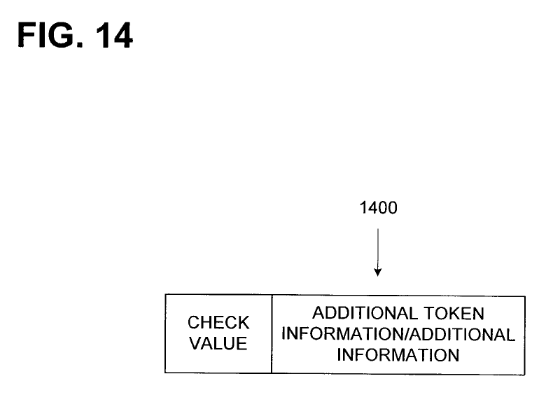

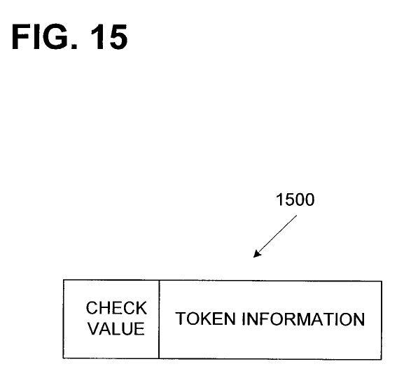

In some embodiments it is contemplated that a check value may be algorithmically computed from the token information and the check value compared against a store value or check value that is obtained from a database. In one embodiment of the invention, the check value is determined from the token information itself, for instance, via a check for internal consistency. As shown in FIG. 13, at step 1301, additional token information may be retrieved, and in step 1302, a check value is computed algorithmically from the additional token information and from the token information. If, in step 1303, the check value is deemed acceptable, a positive match procedure may be executed at step 1304. If, on the other hand, the check value is not deemed acceptable, a negative match procedure may be executed at step 1305. The algorithm may be as simple as determining whether the additional token information and the token information are identical, or a more complex algorithm may be employed. Alternatively, or in addition thereto, reference to a database, such as a database including a record 1400 shown in FIG. 14, or 1500 shown in FIG. 15, may be made. In FIG. 14, the check value correlates with either additional token information or additional information, and in FIG. 15, the check value correlates with token information.

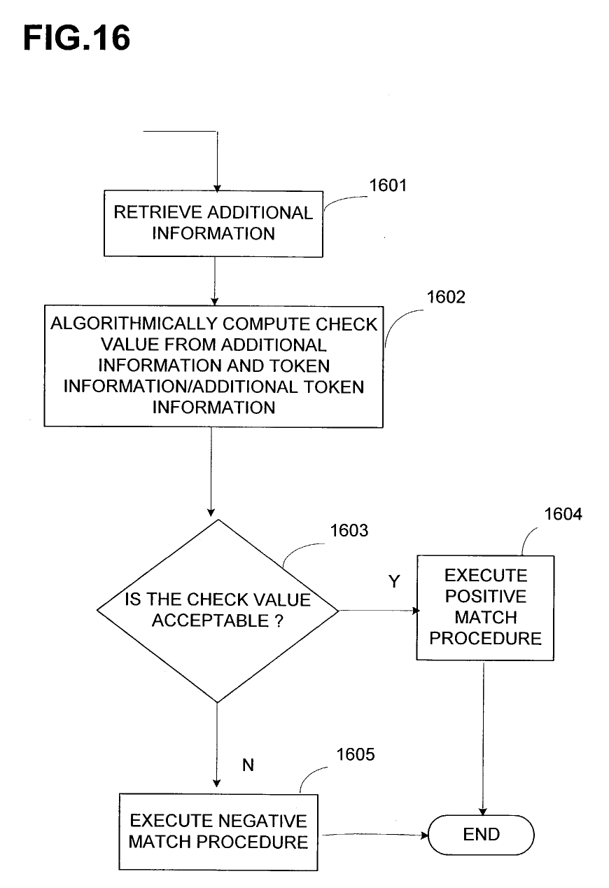

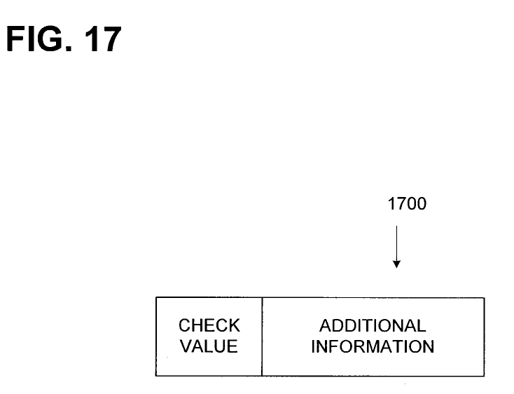

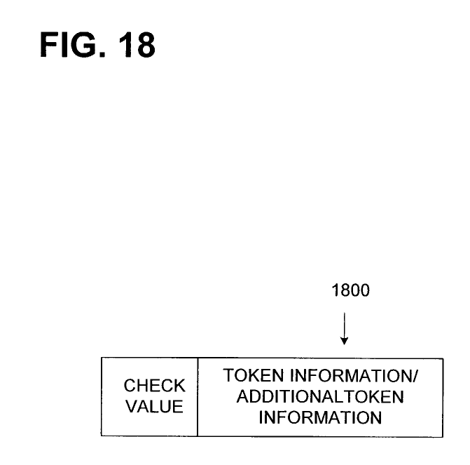

FIGS. 16-18 are generally comparable to FIGS. 13-15, except that in FIGS. 16-18, instead of, or in addition to, additional token information, additional information is retrieved at step 1601, and a check value is algorithmically computed from the additional information. Again, the algorithm may be simple, and reference to a database may or may not be necessary.

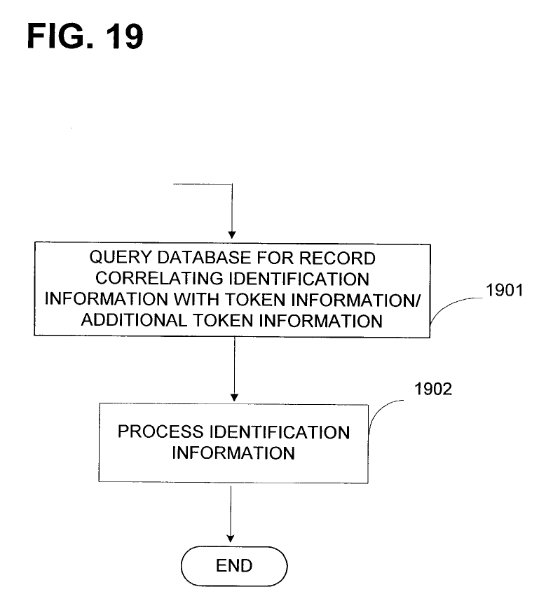

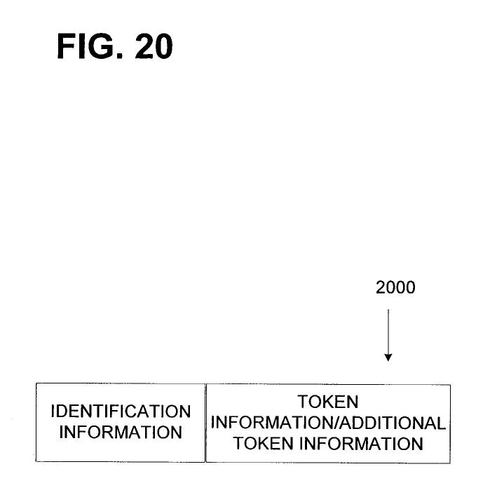

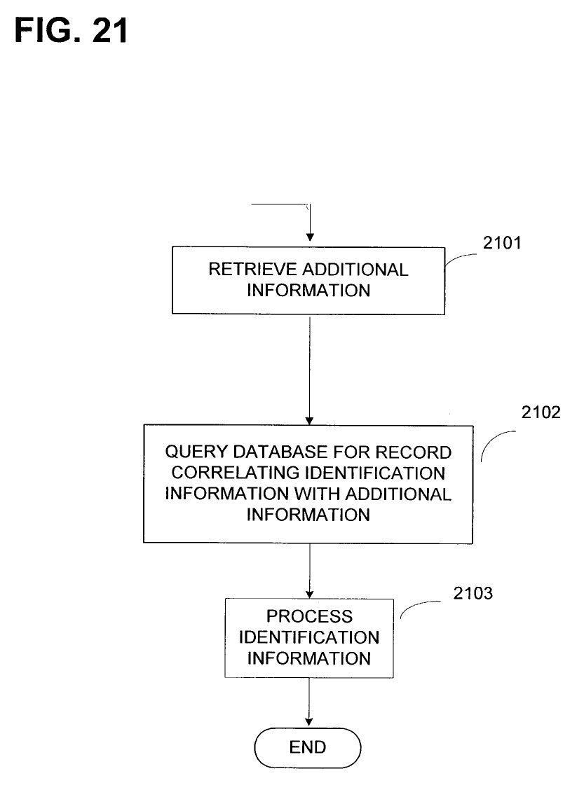

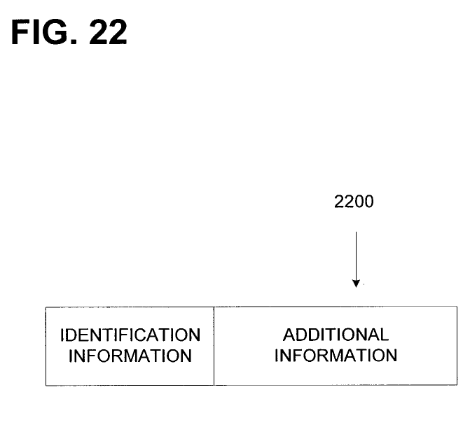

In some embodiments of the invention the token may be associated with a particular individual or lot number, or the token may be correlated in the database record with a particular individual or lot number. For instance, the token may be a warehouse tag wherein the token is attached to a parcel stored in the warehouse or it is associated in a database record with a particular parcel. As shown in FIG. 19, the processing of the token may include querying a database for a record that correlates identification information with either token information or additional token information in step 1901 and processing such identification information in step 1902. For instance, the processing of the identification information may be entering the storage location of a warehouse parcel in a warehouse database. If the token is a hotel chit, the processing of the identification information may be, for instance, charging the purchase of a meal to the guest's hotel room account. Database record 2000, shown in FIG. 20, may include identification information correlating with token information and/or with additional token information. FIGS. 21 and 22 are generally comparable to FIGS. 19 and 20, except that additional information, such as a personal identification number, is received and is used in connection with the database query.

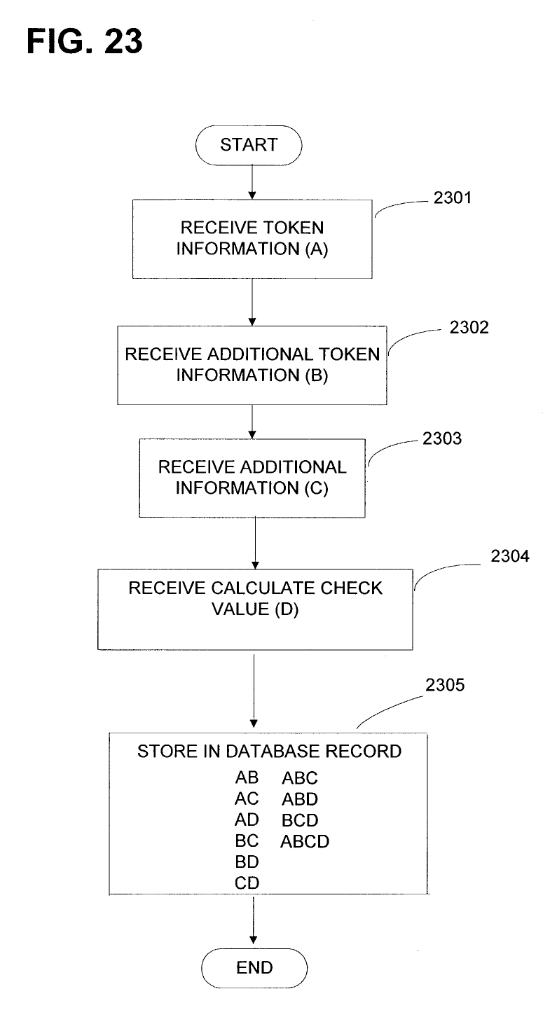

It is contemplated that in some embodiments of the invention some entity, such as an enterprise or a database application service provider, will store information in a database record. As shown in FIG. 23, token information, additional token information and a check value may be received at steps 2301-2304, respectively (any one or two of these steps may be omitted). At step 2305, at least two of the foregoing types of information are stored in a database record. In some embodiments of the invention, identification information is also stored in a database record along with one or more of token information, additional token information, additional information, and a check value.

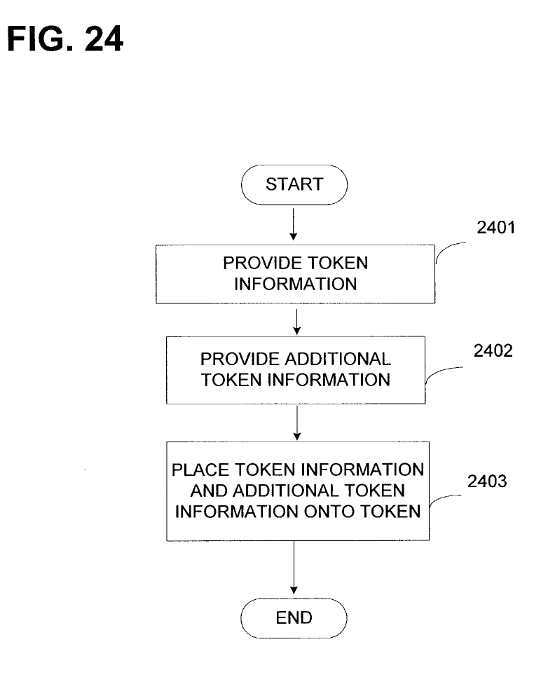

As illustrated in FIG. 24, an entity such as the enterprise or a token manufacturer may be required to place information on a token. In step 2401, token information is provided, and additional token information is provided in step 2402. At step 2403, token information and additional token information are placed onto a token. For instance, the token may be airline ticket, and the token information and additional token information may be placed onto the token by the airline. It is contemplated in some embodiments of the invention that different entities may perform different steps in such method.

The illustrated flowcharts and database records are highly idealized, and it is contemplated that in practice other steps will be added. It is thus seen that the invention provides an authentication token and numerous security and authentication methods.

All references cited herein are hereby incorporated by reference.

All methods described herein can be performed in any suitable order unless otherwise indicated herein or otherwise clearly contradicted by context. The use of any and all examples or exemplary language provided herein is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A token comprising
a substrate;
in either order disposed over a least a portion of said substrate,
a magnetically writeable layer, said magnetically writeable layer comprising a plurality of magnetically alignable particles disposed in a thermosoft medium; and
a thermally writeable layer, said thermally writeable layer comprising a material that is susceptible to a change in color upon heating.

2. A token according to claim 1, said substrate comprising paper.

3. A token according to claim 1, said token further comprising a topcoat layer.

4. A token according to claim 1, said magnetically writeable layer being disposed beneath said thermally writeable layer.

5. A token according to claim 1, said token having disposed thereon a thermally written image, and, in registration with said image, a magnetically written image.

6. A token comprising
a substrate; and
a thermally and magnetically writeable layer disposed over at least a portion of said substrate, said layer including magnetically alignable particles disposed in a thermosoft medium and said layer being susceptible to a change in color upon heating.

7. A token according to claim 6, said substrate comprising paper.

8. A token according to claim 6, said token further comprising a topcoat layer.

9. A token according to claim 8, said substrate comprising paper.

10. A token according to claim 6, said token having disposed thereon a thermally written image, and, in registration with said image, a magnetically written image.

11. A method for preparing a token, comprising:
providing a substrate;
in either order
placing a magnetically writeable layer onto said substrate over at least a portion of said substrate, said magnetically writeable layer comprising a plurality of magnetically alignable particles disposed in a thermosoft medium; and
placing a thermally writeable layer onto said substrate over at least a portion of said substrate to thereby form a laminar structure that includes said substrate, a thermally writeable layer, and a magnetically writeable layer, said thermally writeable layer comprising a material that is susceptible to a change in color upon heating, said thermally writeable layer being in registration with said magnetically writeable layer over at least portion of said substrate.

12. A method according to claim 11, said substrate comprising paper.

13. A method according to claim 11, said further comprising applying a topcoat layer onto said token.

14. A method according to claim 11, wherein said magnetically writeable layer is placed onto said token beneath said thermally writeable layer.

15. A method for preparing a token, comprising
providing a substrate; and
providing a thermally and magnetically writeable layer onto said substrate over at least a portion of said substrate, said layer including magnetically aligned particles disposed in a thermosoft medium and said layer being susceptible to a change in color upon heating.

16. A method according to claim 15, said substrate comprising paper.

17. A method according to claim 15, said further comprising applying a topcoat layer onto said token.

18. A method according to claim 15, wherein said thermally and magnetically writeable layer is placed only a portion of said substrate.

19. A method for imparting a image onto a token, comprising:
providing a token, said token comprising
a substrate;
in either order disposed over a least a portion of said substrate,
a magnetically writeable layer, said magnetically writeable layer comprising a plurality of magnetically alignable particles disposed in a thermosoft medium; and
a thermally writeable layer, said thermally writeable layer comprising a material that is susceptible to a change in color upon heating;
passing at least a portion of said token through a first thermal zone whereby said thermosoft material becomes sufficiently soft to permit magnetic alignment of said particles and whereby said material in said thermally writeable layer changes color; and
simultaneously or subsequently passing said portion of said token through a magnetic zone, whereby said particles become aligned thereby creating a region on said token which bears a magnetically written image in registration with a thermally written image.

20. A method according to claim 19, further comprising passing a different portion of said token through a second thermal zone whereby a thermally written image is generated on said token.

21. A method according to claim 20, wherein said second thermal zone exposes said token to a lower temperature than does said first thermal zone.

22. A method for imparting a image onto a token, comprising:
providing a token, said token comprising:
a substrate; and
a thermally and magnetically writeable layer disposed over at least a portion of said substrate, said layer including magnetically alignable particles disposed in a thermosoft medium and said layer being susceptible to a change in color upon heating;
passing at least a portion of said token through a first thermal zone whereby said thermosoft material becomes sufficiently soft to permit magnetic alignment of said particles and whereby said material in said thermal layer changes color; and
simultaneously or subsequently passing said portion of said token through a magnetic zone, whereby said particles become aligned thereby creating a region on said token which bears a magnetically written image in registration with a thermally written image.

23. A method for reading a token, comprising in any appropriate order:
receiving a token expected to contain a magnetically written image in registration with a thermally written image;
simultaneously, or subsequently in either order, scanning said token and retrieving magnetic image information from said token and retrieving visual image information from said token; and
comparing said magnetic image information and said visual image information.

24. A method according to claim 23, said visual image information being retrieved from said card via machine scanning.

25. A method for selectively executing a positive match procedure, comprising in any appropriate order:
providing a token expected to contain a magnetically written image in registration with a thermally written image;
simultaneously or sequentially in either order scanning said token and retrieving magnetic image information from said token and retrieving visual image from said token;
comprising said magnetic image information and said visual image information; and
executing said positive match procedure only if said magnetic image information matches said visual image information.

26. A method according to claim 25, said method including comparing one of said magnetic image information and said visual image information with expected information, and executing said positive match procedure only if said magnetic image information or said visual image information matches said expected information.

27. A method according to claim 25, said a method including executing said positive match procedure if and only if said magnetic image information matches said visual image information.

28. A method according to claim 27, wherein said expected information is obtained via querying a database for magnetic image information.

29. A method according to claim 28, said database being remote from the point of retrieval of said magnetic image information and said visual image information, said method including communicating with said database over a communication network.

30. A method according to claim 27, wherein said expected information is obtained by scanning said token for additional token information.

31. A method according to claim 25, wherein said expected information is obtained by retrieving additional information.

32. A method for selectively executing a positive match procedure, comprising in any appropriate order:
providing a token expected to contain magnetic image information in registration with visible image information;
determining whether said token includes magnetic image information in registration with visible image information; and
executing said positive match procedure only if said token is determined to contain magnetic image information in registration with visible image information.

33. A method according to claim 33, including executing said positive match procedure if and only if said token is determined to contain magnetic image information in registration with visible image information.

34. A method according to claim 33, including:
obtaining additional token information;
determining whether said additional token information is acceptable; and
executing said positive match procedure only if said additional token information is acceptable.

35. A method according to claim 34, said method including querying a database for a database record that correlates said additional token information with one of additional information, magnetic image information, or visual image information.

36. A method according to claim 34, said method including algorithmically comparing said additional token information with one of additional information, magnetic image information, or visual image information.

37. A method for processing information, comprising;
providing a token expected to contain magnetic image information in registration with visible image information;
determining whether said token contains magnetic image information in registration with visible image information; and
further processing said token only if said token contains magnetic image information in registration with visible image information.

38. A method according to claim 37, comprising further processing said token if and only if said token contains magnetic image information in registration with visible image information.

39. A method according to claim 37, said further processing of said token including querying a database for a record correlating expected information with one of said magnetic image information and said visible image information, and executing a positive match procedure only if a correlation is found.

40. A method according to claim 39, said database being remote from said token and said method including communicating with said database over a communications network.

41. A method according to claim 39, including executing a positive match procedure if and only if a correlation is found.

42. A method according to claim 37, comprising in any appropriate order:
retrieving additional token information from said token;
querying a database for a record correlating said additional token information with one of said magnetic image information and said visible image information; and
executing a positive match procedure only if a correlation is found.

43. A method according to claim 42, said database being remote from said token and said method including communicating with said database over a communications network

44. A method according to claim 42, including executing a positive match procedure if and only if a correlation is found.

45. A method according to claim 37, comprising in any appropriate order:
retrieving additional information;
querying a database for a record correlating said additional information with one of said magnetic image information, said visible image information, and additional token information; and
executing a positive match procedure only if a correlation is found.

46. A method according to claim 45, said method including querying said database for a record correlating said additional information with additional token information.

47. A method according to claim 42, said database being remote from said token and said method including communicating with said database over a communications network

48. A method according to claim 42, including executing a positive match procedure if and only if a correlation is found.

49. A method according to claim 37, comprising in any appropriate order
receiving additional token information;
algorithmically computing a check value from said additional token information and one of said magnetic image information and said visible image information; and
executing said positive match procedure only if said check value is deemed acceptable.

50. A method according to claim 49, comprising:
querying a database for a record correlating said check value with one of said additional token information and additional information; and
executing said positive match procedure only if a correlation is found.

51. A method according to claim 50, said database being remote from said token and said method including communicating with said database over a communications network.

52. A method according to claim 37, comprising in any appropriate order
receiving additional information;
algorithmically computing a check value from said additional information and one of said magnetic image information, said visible image information, and additional token information; and
executing a positive match procedure only if said check value is deemed acceptable.

53. A method according to claim 52, comprising:
querying a database for a record correlating said check value with one of said additional information, magnetic image information, visible image information, and additional token information; and
executing a positive match procedure only if a correlation is found.

54. A method according to claim 53, said database being remote from said token and said method including communicating with said database over a communications network

55. A method according to claim 37, said further processing of said token including querying a database for a record correlating identification information with one of said magnetic image information, said visible image information, and additional token information, and processing said identification information.

56. A method according to claim 55, said database being remote from said token and said method including communicating with said database over a communications network

57. A method according to claim 37, said further processing of said token including
retrieving additional information,
querying a database for a record correlating said additional information with identification information; and
processing said identification information.

58. A method for providing a database record, comprising:
receiving database information said database information include at least two of the following (A)-(D): for at least one token in an array of tokens, each token in said array containing magnetic image information in registration with visible image information:
(A) token information, said token information comprising one of magnetic image information and visible image information.
(B) additional token information;
(C) additional information; and
(D) a check value that is algorithmically related to at least two of (A)-(C); and
storing said database information in a database record.

59. A method according to claim 58, including calculating said check value (D).
